(19) United States
(12) Patent Application Publication
(10) Pub. No.: US 2024/0059566 A1
(43) Pub. Date: Feb. 22, 2024

(54) Method for producing by-product yellow phosphorus slag from yellow phosphorus by unconventional electric furnace process, and use

(71) Applicant: Zhengzhou University, Zhengzhou City (CN)

(72) Inventors: Cuihong HOU, Zhengzhou City (CN); Shouyu GU, Zhengzhou City (CN); Yuan YAO, Zhengzhou City (CN); Haobin WANG, Zhengzhou City (CN); Yuqiong LIU, Zhengzhou City (CN); Hongling GUAN, Zhengzhou City (CN)

(73) Assignee: Zhengzhou University, Zhengzhou City (CN)

(21) Appl. No.: 18/451,699

(22) Filed: Aug. 17, 2023

(30) Foreign Application Priority Data
Aug. 17, 2022 (CN) 202210983870.X

(51) Int. Cl. C01B 25/027; C01B 25/047; C05B 5/00; C05B 7/00; C05B 19/00

(52) U.S. Cl. CPC C01B 25/027; C01B 25/047; C05B 5/00; C05B 7/00; C05B 19/00

(57) ABSTRACT

The present disclosure provides a method for producing value-added by-product yellow phosphorus slag through an unconventional electric furnace process, derived from yellow phosphorus. This method is related to the technical field of comprehensive utilization of mineral resources. The disclosed method involves the following steps: mixing mid-low-grade phosphate rock, silica, coke, and a cosolvent to create a blended material, subjecting the blended material to high-temperature reduction in a yellow phosphorus electric furnace to yield yellow phosphorus and water-quenched slag, and then drying the water-quenched slag using yellow phosphorus tail gas to obtain the yellow phosphorus slag. According to this disclosure, a P₂O₅—CaO—SiO₂—MgO—R multi-component system is established using the blended material.

### CROSS REFERENCE TO RELATED APPLICATION

This patent application claims the benefit and priority of Chinese Patent Application No. 202210983870.X, filed with the China National Intellectual Property Administration on Aug. 17, 2022, the disclosure of which is incorporated by reference herein in its entirety as part of the present application.

### TECHNICAL FIELD

The present disclosure relates to the technical field of comprehensive utilization of mineral resources, in particular to a method for producing a by-product yellow phosphorus slag from yellow phosphorus by an unconventional electric furnace process, and use.

### BACKGROUND

Yellow phosphorus slag is a solid waste produced during the production of industrial yellow phosphorus by electric furnace process. Specifically, raw materials such as phosphate rock, silica, and coke are heated to temperatures ranging from 1,400° C. to 1,600° C. using electric energy in an electric furnace, resulting in a molten furnace charge. Through the decomposition and reduction, furnace gas containing phosphorus is generated, and then enters a condensing system. After a series of processes including separation and refining, when the yellow phosphorus is obtained through coagulation and separation, a high-temperature molten slag in the electric furnace is discharged to obtain the yellow phosphorus slag. Yellow phosphorus slag mainly includes SiO₂ and CaO, and also contains a small amount of other impurities such as Fe₂O₃, MgO, and P₂O₅. According to the status quo of production process, 8 tons to 10 tons of slag may be generated for every 1 ton of yellow phosphorus produced. A huge amount of slag discharge and a large amount of tail gas emitted during the processing has become a major technical bottleneck restricting the sustainable development of phosphorus chemical industry by thermal process.

Rice is a silicon-loving crop. To produce 1 ton of rice, SiO₂ absorbed from the land exceeds the sum of nitrogen, phosphorus, and potassium absorbed by rice. Silicon can enhance the stress resistance of plants and help plants stand upright. This element can also balance nutrients, improve crop quality, and promote desirable root growth and photosynthesis. Moreover, silicon fertilizers can enhance soil looseness and increase crop yields, and its application in low-silicon soils can greatly improve the crop yields.

At present, yellow phosphorus slag is mainly used in cement and cement-related cementitious materials, unburned bricks, and concrete. Accordingly, it is very necessary to combine the chemical elements in phosphorus slag with fertilizers, improve the yield and quality of crops, and promote the green and healthy development of phosphorus chemical industry.

### SUMMARY

In view of this, the objective of the present disclosure is to provide a method for producing a by-product yellow phosphorus slag from yellow phosphorus by an unconventional electric furnace process, and use. This method lowers a fusion temperature of materials. The yellow phosphorus slag as a fertilizer increases an application value of the yellow phosphorus slag.

To achieve the above objective, the present disclosure provides the following technical solutions:

The present disclosure provides a method for producing a by-product yellow phosphorus slag from yellow phosphorus by an unconventional electric furnace process, including the following steps: mixing mid-low-grade phosphate rock, silica, coke, and a cosolvent to obtain a mixed material, and subjecting the mixed material to high-temperature reduction in a yellow phosphorus electric furnace to obtain yellow phosphorus and a water-quenched slag; and drying the water-quenched slag with a yellow phosphorus tail gas to obtain the yellow phosphorus slag; where the cosolvent is one selected from the group consisting of boromagnesite, potassium feldspar, boric anhydride, borax, potassium sulfate, and sodium sulfate.

Preferably, the mid-low-grade phosphate rock includes P₂O₅ with a content of greater than or equal to 23%.

Preferably, the cosolvent is added at 0.1% to 10% of a weight of the mixed material based on a main oxide in the cosolvent.

Preferably, SiO₂ and CaO in the mixed material are at a mass ratio of (0.7-0.9):1.

The present disclosure further provides use of a yellow phosphorus slag prepared by the method in preparation of a fertilizer.

Preferably, the fertilizer is applicable to rice.

Preferably, the fertilizer includes urea, monoammonium phosphate, potassium chloride, yellow phosphorus slag, a calcium magnesium phosphate fertilizer, zinc sulfate, ammonium chloride, and attapulgite that are at a mass ratio of (15-30):(10-15):(20-25):(15-25):(3-7):(0.1-2):(10-30):(1-5).

Preferably, a preparation method of the fertilizer includes: mixing the urea, the monoammonium phosphate, the potassium chloride, the yellow phosphorus slag, the calcium magnesium phosphate fertilizer, the zinc sulfate, the ammonium chloride, and the attapulgite to allow granulation, drying, cooling, sieving, and packaging to obtain the fertilizer.

Preferably, the granulation refers to one selected from the group consisting of extrusion granulation, powder granulation, and coated fertilizer granulation with the urea as a core.

Preferably, the fertilizer is used as a base fertilizer applied at 35 kg/mu to 50 kg/mu.

Compared with the prior art, the present disclosure has the following beneficial effects:

The present disclosure provides a method for producing a by-product yellow phosphorus slag from yellow phosphorus by an unconventional electric furnace process, including the following steps: mixing mid-low-grade phosphate rock, silica, coke, and a cosolvent to obtain a mixed material, and subjecting the mixed material to high-temperature reduction in a yellow phosphorus electric furnace to obtain yellow phosphorus and a water-quenched slag; and drying the water-quenched slag with a yellow phosphorus tail gas to obtain the yellow phosphorus slag. In the present disclosure, a P₂O₅—CaO—SiO₂—MgO—R multi-component system is constructed with the mixed material. The system not only ensures a yield of the yellow phosphorus, but also reduces a fusion temperature of materials and energy consumption of a thermal process, thereby enhancing a utilization value of the yellow phosphorus slag and realizing energy saving and consumption reduction. The yellow phosphorus slag is used in fertilizers to provide medium and trace elements for crops and improve a yield and a quality of the crops. In this way, the yellow phosphorus slag is utilized with a high value to promote the green and healthy development of phosphorus chemical industry.

### BRIEF DESCRIPTION OF THE DRAWINGS

FIG. 1 shows a process schematic diagram of the method for producing a by-product yellow phosphorus slag from yellow phosphorus by an unconventional electric furnace process of the present disclosure in joint production of a fertilizer;

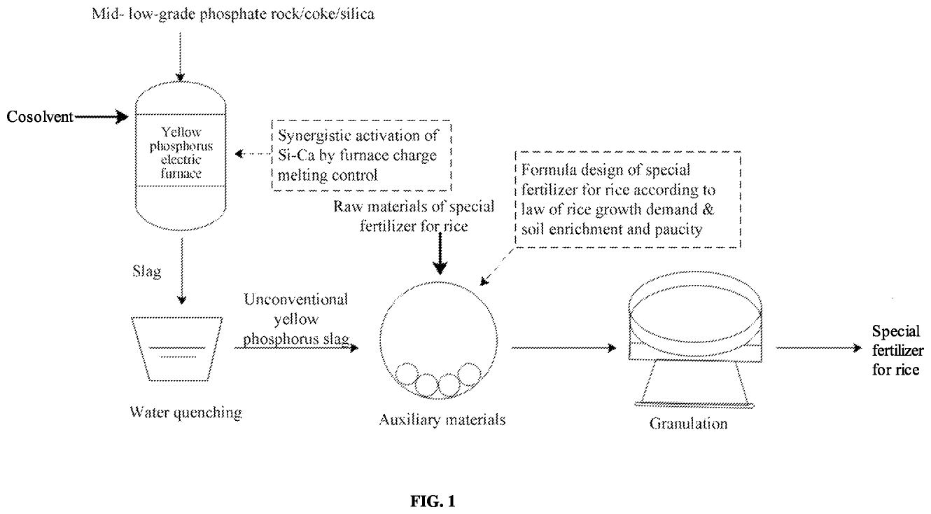

FIG. 2 shows a device for producing yellow phosphorus by an electric furnace process; 1-phosphorus recovery device, 2-nitrogen cylinder, 3-refractory material, 4-furnace body, 5-sample, 6-thermocouple, 7-graphite crucible, 8-base, 9-electric control cabinet;

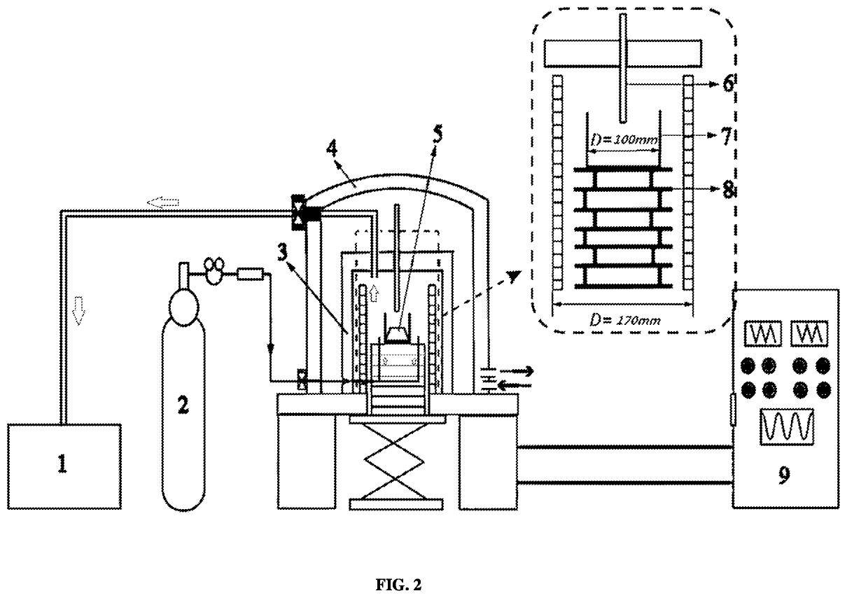

FIG. 3 shows an influence of boromagnesite on a fusion characteristic temperature of materials under different additions; and

FIG. 4A shows an influence of a cosolvent on the deformation temperature DT, softening temperature ST, and fusion temperature FT;

FIG. 4B is another comparison diagram of showing an influence of a cosolvent on the deformation temperature DT, softening temperature ST, and fusion temperature FT;

FIG. 4C is still another comparison diagram of showing an influence of a cosolvent on the deformation temperature DT, softening temperature ST, and fusion temperature FT; and

FIG. 4D is yet another comparison diagram of showing an influence of a cosolvent on the deformation temperature DT, softening temperature ST, and fusion temperature FT.

### DETAILED DESCRIPTION OF THE EMBODIMENTS

The present disclosure provides a method for producing a by-product yellow phosphorus slag from yellow phosphorus by an unconventional electric furnace process, including the following steps: mixing mid-low-grade phosphate rock, silica, coke, and a cosolvent to obtain a mixed material, and subjecting the mixed material to high-temperature reduction in a yellow phosphorus electric furnace to obtain yellow phosphorus and a water-quenched slag; and drying the water-quenched slag with a yellow phosphorus tail gas to obtain the yellow phosphorus slag; where the cosolvent is preferably one selected from the group consisting of boromagnesite, potassium feldspar, boric anhydride, borax, potassium sulfate, and sodium sulfate.

In the present disclosure, a P₂O₅—CaO—SiO₂—MgO—R multi-component system (R includes one of Al₂O₃, Fe₂O₃, K₂O, Na₂O, B₂O₃, and MnO) is constructed with the mixed material. This system can not only reduce a fusion temperature, lower a quality requirement of the yellow phosphate rock, and ensure an extraction rate of yellow phosphorus. The elements contained in the system can also provide beneficial medium and trace elements for rice, promote the growth of rice, and improve the yield and quality of rice.

In the present disclosure, the cosolvent can promote the melting of calcium phosphate, wollastonite and other phases in the materials, thereby reducing the fusion temperature of the materials.

In the present disclosure, the content of P₂O₅ in the mid-low-grade phosphate rock is preferably greater than or equal to 23%. Based on a main oxide in the cosolvent, the cosolvent is added at preferably 0.1% to 10%, more preferably 8% of a weight of the mixed material. SiO₂ and CaO in the mixed material are at a mass ratio of preferably (0.7-0.9):1, more preferably 0.8:1. A tail gas of the yellow phosphorus preferably includes 80% to 95% of CO, more preferably 90% of CO.

The present disclosure further provides use of a yellow phosphorus slag prepared by the method in preparation of a fertilizer. In the present disclosure, the by-product yellow phosphorus slag obtained during the preparation of yellow phosphorus mainly includes CaO and SiO₂, and also contains a small amount of “residual phosphorus,” most of which exist in the form of P₂O₅. These elements can be better absorbed by rice to meet the various nutrients needed for rice growth.

In the present disclosure, the fertilizer is preferably applicable to rice.

In the present disclosure, the fertilizer includes preferably urea, monoammonium phosphate, potassium chloride, yellow phosphorus slag, a calcium magnesium phosphate fertilizer, zinc sulfate, ammonium chloride, and attapulgite that are at a mass ratio of (15-30):(10-15):(20-25):(15-25):(3-7):(0.1-2):(10-30):(1-5), more preferably 25:12:23:20:5:1:20:3. Urea provides a significant amount of elemental nitrogen required for rice growth; monoammonium phosphate supplies essential elements such as nitrogen and phosphorus necessary for rice growth. Potassium chloride furnishes the crucial macroelement potassium required by rice. Yellow phosphorus slag offers elemental calcium and silicon needed for rice growth. Calcium magnesium phosphate fertilizer delivers elements like calcium, magnesium, phosphorus, and silicon necessary for rice growth. Zinc sulfate contributes the essential zinc required for rice growth. Attapulgite enhances the absorption of nitrogen, phosphorus, and potassium by rice, promoting synergistic effects among the fertilizer components. Each ingredient of the fertilizer works together to fulfill the macro, medium, and trace element requirements during the rice growth process. Furthermore, these components contribute to upright plant growth, improved photosynthetic efficiency, lodging resistance, and enhanced resilience against diseases and pests. As a result, they contribute to the overall improvement of rice quality and yield.

In the present disclosure, a preparation method of the fertilizer includes preferably: mixing the urea, the monoammonium phosphate, the potassium chloride, the yellow phosphorus slag, the calcium magnesium phosphate fertilizer, the zinc sulfate, the ammonium chloride, and the attapulgite to allow granulation, drying, cooling, sieving, and packaging to obtain the fertilizer.

In the present disclosure, the granulation refers to preferably extrusion granulation, powder granulation, and coated fertilizer granulation with the urea as a core.

In the present disclosure, the fertilizer is preferably used as a base fertilizer applied at preferably 35 kg/mu to 50 kg/mu, more preferably 40 kg/mu.

The technical solution provided by the present disclosure will be described in detail below with reference to the examples, but they should not be construed as limiting the claimed scope of the present disclosure.

In the examples, the mid-low-grade phosphate rock is Yunnan yellow phosphorus rock, and its main chemical composition is shown in Table 1; a main chemical composition of silica is shown in Table 2; a main chemical component of coke is shown in Table 3; a main chemical composition of boromagnesite is shown in Table 4; a main chemical composition of potassium feldspar is shown in Table 5.

TABLE 1
Chemical composition of Yunnan yellow phosphorus rock.

| | Component | | | | | | | | |
|---|---|---|---|---|---|---|---|---|---|
| | P₂O₅ | SiO₂ | CaO | MgO | Fe₂O₃ | Al₂O₃ | K₂O | Na₂O | MnO |
| Content/% | 26.49 | 18.97 | 40.28 | 1.93 | 1.1 | 1.43 | 0.32 | 0.16 | 0.1 |

TABLE 2
Main chemical composition of silica

| | Component | | | | | | | | |
|---|---|---|---|---|---|---|---|---|---|
| | SiO₂ | CaO | Al₂O₃ | P₂O₅ | MgO | Fe₂O₃ | K₂O | Na₂O | MnO |
| Content/% | 87.3 | 2.22 | 3.35 | 1.6 | 0.36 | 0.93 | 0.6 | 0.21 | 0.01 |

TABLE 3
Main chemical composition of coke

| | Component | | | | | | | |
|---|---|---|---|---|---|---|---|---|
| | volatile | Fixed | Ash | Chemical composition of ash | | | | |
| | matter | carbon | content | TFe | SiO₂ | CaO | Al₂O₃ | MgO |
| Content | 2.85 | 74.52 | 17.95 | 3.60 | 6.52 | 1.69 | 3.83 | 0.21 |

TABLE 4
Main chemical composition of boromagnesite

| | Component | | | |
|---|---|---|---|---|
| | CaO | MgO | B₂O₃ | Loss on ignition |
| Content/% | 4.43 | 59.69 | 15.96 | 12.44 |

TABLE 5
Main chemical composition of potassium feldspar

| | Component | | | | | | |
|---|---|---|---|---|---|---|---|
| | P₂O₅ | SiO₂ | CaO | MgO | Al₂O₃ | K₂O | Loss on ignition |
| Content/% | 0.74 | 76.82 | 0.204 | 0.076 | 4.57 | 9.34 | 6.17 |

In the present disclosure, there is no special limitation on raw materials whose sources are not mentioned, and conventional commercially available products in this field can be used.

### Example 1

Preparation of materials: 35.3017 g of mid-low-grade phosphate rock, 7.0225 g of silica, 6.2192 g of coke, and 1.4567 g of boromagnesite were used. A mass ratio of SiO₂ and CaO in the material was 0.8:1.

The above materials were mixed and placed in a graphite crucible, placed in a constant-temperature zone at a preset temperature of 800° C. and filled with nitrogen, heated to a melting point and reacted at a constant temperature for 1 h; the crucible was quickly taken out and a resulting molten slag was poured into water, and dried with 90% CO-containing yellow phosphorus tail gas to obtain a yellow phosphorus slag.

### Examples 2 to 6

A preparation method of the yellow phosphorus in Examples 2 to 6 was identical with Example 1, except that the preparation of materials was different. The preparation of materials in Examples 2 to 6 was shown in Table 6.

TABLE 6
Preparation of materials in Examples 2 to 6.

| | Mid-low- | | | | | | |
|---|---|---|---|---|---|---|---|
| | grade | | | | | Addition | Mass |
| | phosphate | | | Cosolvent | | amount of | ratio of |
| Group | rock/g | Silica/g | Coke/g | Type | Dosage/g | cosolvent/% | SiO₂/CaO |
| Example 2 | 37.575 | 5.826 | 6.5971 | Boric | 1.5306 | 3 (based on B₂O₃ | 0.80 |
| | | | | anhydride | | content) | |
| Example 3 | 37.575 | 5.826 | 6.5971 | Borax | 4.1085 | 3 (based on B₂O₃ | 0.80 |
| | | | | | | content) | |
| Example 4 | 37.242 | 1.4408 | 6.4806 | Potassium | 4.8356 | 1 (based on K₂O | 0.80 |
| | | | | feldspar | | content) | |
| Example 5 | 37.575 | 5.826 | 6.5971 | Potassium | 4.2956 | 3 (based on K₂O | 0.80 |
| | | | | sulfate | | content) | |
| Example 6 | 37.575 | 5.826 | 6.5971 | Sodium | 3.4723 | 3 (based on Na₂O | 0.80 |
| | | | | sulfate | | content) | |

### Example 7

30 kg of urea, 12 kg of monoammonium phosphate, 23 kg of potassium chloride, 15 kg of the yellow phosphorus slag in Example 1, 5 kg of calcium magnesium phosphate fertilizer, 1 kg of zinc sulfate, 10 kg of ammonium chloride, and 3 kg of attapulgite were weighed.

The above materials were uniformly mixed to allow extrusion granulation, drying, cooling, sieving, and packaging to obtain the fertilizer.

### Example 8

25 kg of urea, 10 kg of monoammonium phosphate, 20 kg of potassium chloride, 20 kg of the yellow phosphorus slag in Example 2, 3 kg of calcium magnesium phosphate fertilizer, 0.1 kg of zinc sulfate, 20 kg of ammonium chloride, and 1 kg of attapulgite were weighed.

The above materials were pulverized and mixed evenly, subjected to powder granulation by a disk granulator, followed by drying, cooling, sieving, and packaging to obtain the fertilizer.

### Example 9

15 kg of urea, 10 kg of monoammonium phosphate, 20 kg of potassium chloride, 25 kg of the yellow phosphorus slag in Example 2, 3 kg of calcium magnesium phosphate fertilizer, 0.1 kg of zinc sulfate, 25 kg of ammonium chloride, and 1 kg of attapulgite were weighed.

The above materials were pulverized and mixed evenly, subjected to powder granulation by a rotor drum granulator, followed in the drying, cooling, sieving, and packaging to obtain the fertilizer.

### Example 10

26 kg of urea, 15 kg of monoammonium phosphate, 20 kg of potassium chloride, 20 kg of yellow phosphorus slag in Example 2, 7 kg of calcium magnesium phosphate fertilizer, 2 kg of zinc sulfate, 15 kg of ammonium chloride, and 3 kg of attapulgite were weighed.

Among the raw materials, urea should be in a granular form, while other raw materials should be in a powder form. All powdery raw materials were mixed to form a mixed material for subsequent use. The granular urea and powdery materials were added in sequence, subjected to coated fertilizer granulation with the urea as a core, followed in the drying, cooling, sieving, and packaging to obtain the fertilizer.

### Experimental Example 1

Influence of different additions of cosolvent on a fusion characteristic temperature of the material and a yield of yellow phosphorus.

1. Influence of Different Ratios of Boromagnesite on a Fusion Characteristic Temperature and a Yield of Yellow Phosphorus.

The yellow phosphorus was prepared at the amounts of raw materials according to Table 7, and a preparation method of the yellow phosphorus was the same as that in Example 1.

TABLE 7
Matching of materials after adding different ratios of boromagnesite.

| Mid-low-grade | | | | Addition of | |
|---|---|---|---|---|---|
| phosphate rock/g | Silica/g | Coke/g | Boromagnesite/g | boromagnesite/% | SiO₂/CaO |
| 36.7458 | 6.5422 | 6.4631 | 0.2488 | 0.5 | 0.85 |
| 36.4601 | 6.6302 | 6.4147 | 0.4951 | 1 | 0.85 |
| 35.8735 | 6.8304 | 6.3154 | 0.9807 | 2 | 0.87 |
| 35.3017 | 7.0225 | 6.2192 | 1.4567 | 3 | 0.89 |
| 34.7572 | 7.1927 | 6.1269 | 1.9231 | 4 | 0.90 |

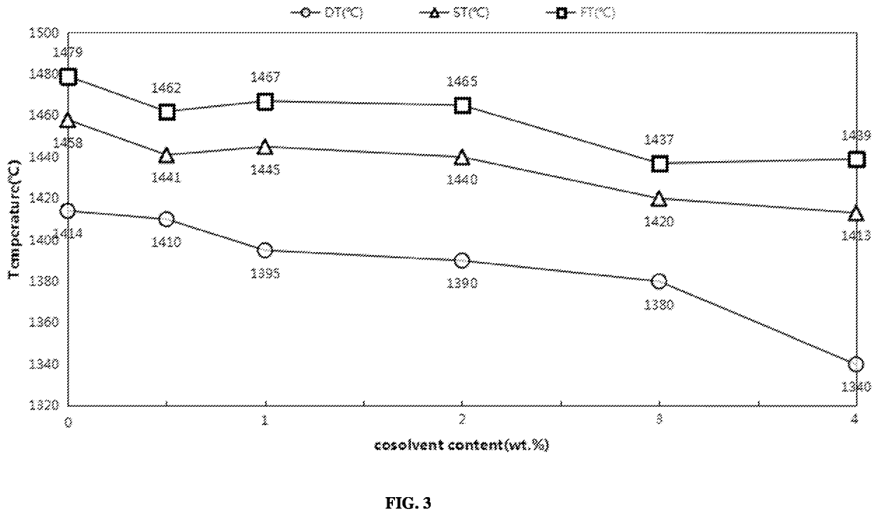

In preparing the yellow phosphorus, a temperature change of the phase melting point and the yield of yellow phosphorus were observed under adding different proportions of boromagnesite by using a computerized ash melting point instrument. The specific results were shown in Table 8, Table 9, and FIG. 3.

A determination method of yellow phosphorus yield (phosphorus escape rate) was as follows:

During the smelting reduction of phosphate, when a certain temperature was reached, phosphorus might volatilize. Therefore, the volatilization and migration of phosphorus could be characterized by measuring a phosphorus content of the sample before and after reduction by chemical analysis. According to the law of material conservation, a calculation formula was shown in formula (1):

X=w₀−w₁/w₁×100% formula (1)
in formula (1):
X represented the yellow phosphorus yield (phosphorus escape rate), in %;
W₀ represented a mass of phosphorus in a furnace pre-slag, in g; and
W₁ represented a residual mass of phosphorus in a resulting residue, in g.

TABLE 8
Influence of different boromagnesite additions on
fusion characteristic temperature of materials.

| | Deformation | Softening | Fusion |
|---|---|---|---|
| Boromagnesite | temperature | temperature | temperature |
| addition/% | DT/° C. | ST/° C. | FT/° C. |
| 0 | 1414 | 1458 | 1479 |
| 0.5 | 1410 | 1441 | 1462 |
| 1.00 | 1395 | 1445 | 1467 |
| 2.00 | 1390 | 1460 | 1465 |
| 3.00 | 1380 | 1420 | 1437 |
| 4.00 | 1340 | 1413 | 1439 |

As shown in Table 8 and FIG. 3, the boromagnesite had a significant fluxing effect. When adding 3% of boromagnesite, the fusion temperature of the material could be reduced by 42° C.

TABLE 9
Influence of different boromagnesite
additions on yellow phosphorus yield.

Yellow phosphorus yield/%

| | Reaction | Reaction | Reaction |
|---|---|---|---|
| Addition of | temperature | temperature | temperature |
| boromagnesite/% | at 1,350° C. | at 1,400° C. | at 1,450° C. |
| 0 | 78.45 | 89.48 | 92.14 |
| 0.5 | 80.08 | 88.17 | 97.86 |
| 1 | 77.93 | 91.88 | 97.33 |
| 2 | 85.73 | 94.04 | 96.01 |
| 3 | 82.07 | 94.04 | 94.36 |
| 4 | 86.50 | 94.08 | 90.90 |

As shown in Table 9, with an increase of the added amount of boromagnesite, the yellow phosphorus yield changed irregularly. In this experiment, when the amount of boromagnesite was added to 0.5% and the reaction temperature was 1,450° C., the yellow phosphorus yield could reach 97.86%.

2. Influence of Different Proportions of Boric Anhydride, Potassium Sulfate, and Sodium Sulfate on Fusion Characteristic Temperature and Yellow Phosphorus Yield

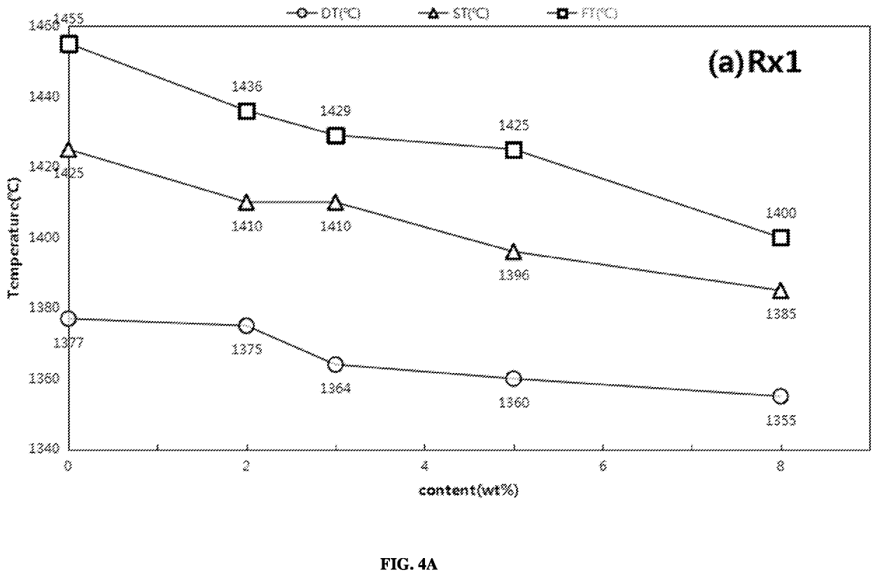

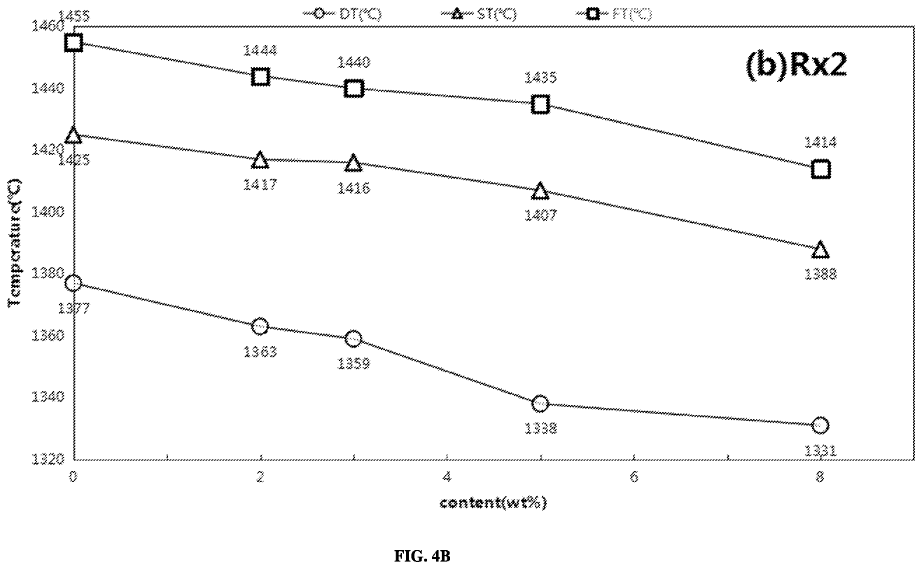

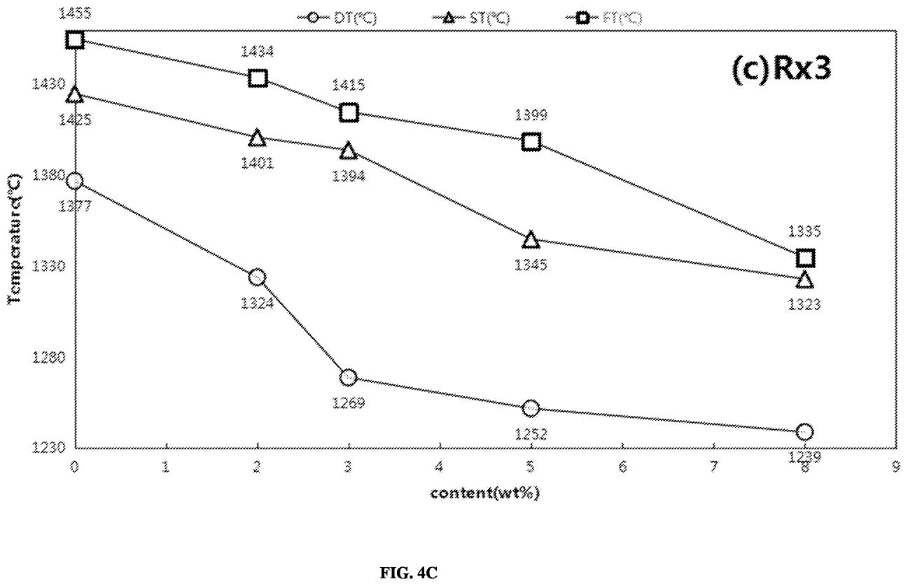

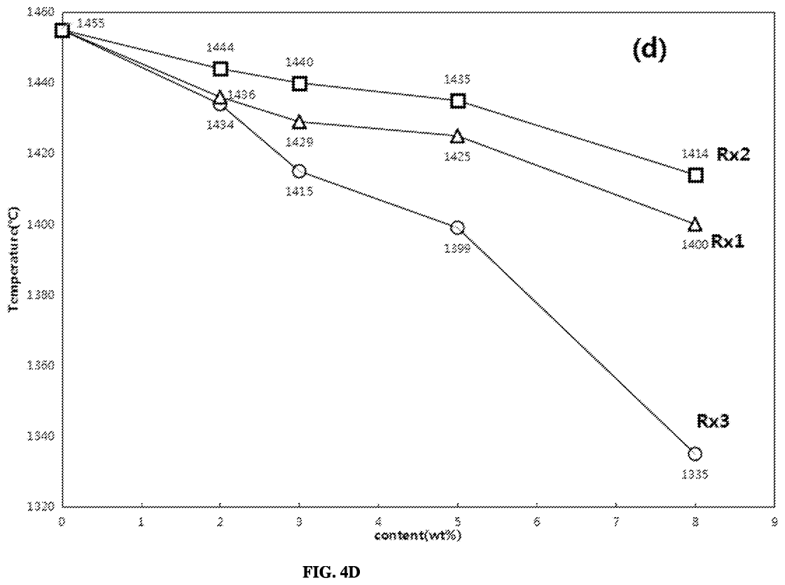

When an addition amount of cosolvents, boric anhydride, potassium sulfate, and sodium sulfate, was 2%, 3%, 5%, and 8% separately (Table 10), the yellow phosphorus was prepared by the method of Example 1. The results of the cosolvents, boric anhydride, potassium sulfate, and sodium sulfate on the reflow characteristic temperature of the materials were shown in Table 11, Table 12, and FIGS. 4A-D.

TABLE 10
Matching of materials after adding different ratios of cosolvents.

| | | Mid-low- | | | | |
|---|---|---|---|---|---|---|
| | | grade | | | | |
| Cosolvent | Addition/ | phosphate | | | Cosolvent | SiO₂/ |
| type | % | rock/g | Silica/g | Coke/g | addition/g | CaO |
| Boric | 2 | 37.575 | 5.826 | 6.5971 | 1.0204 | 0.80 |
| anhydride | 3 | 37.575 | 5.826 | 6.5971 | 1.5306 | 0.80 |
| | 5 | 37.575 | 5.826 | 6.5971 | 2.5510 | 0.80 |
| | 8 | 37.575 | 5.826 | 6.5971 | 4.0816 | 0.80 |
| Potassium | 2 | 37.575 | 5.826 | 6.5971 | 2.8637 | 0.80 |
| sulfate | 3 | 37.575 | 5.826 | 6.5971 | 4.2956 | 0.80 |
| | 5 | 37.575 | 5.826 | 6.5971 | 7.1593 | 0.80 |
| | 8 | 37.575 | 5.826 | 6.5971 | 11.4548 | 0.80 |
| Sodium | 2 | 37.575 | 5.826 | 6.5971 | 2.3148 | 0.80 |
| sulfate | 3 | 37.575 | 5.826 | 6.5971 | 3.4723 | 0.80 |
| | 5 | 37.575 | 5.826 | 6.5971 | 5.7871 | 0.80 |
| | 8 | 37.575 | 5.826 | 6.5971 | 9.2594 | 0.80 |

TABLE 11
Influence of cosolvents boric anhydride, potassium sulfate, and
sodium sulfate on reflow characteristic temperature of materials.

| | | Deformation | Softening | Fusion |
|---|---|---|---|---|
| | | temperature | temperature | temperature |
| Cosolvent | Addition/% | DT/° C. | ST/° C. | FT/° C. |
| Boric | 2 | 1375 | 1410 | 1436 |
| anhydride | 3 | 1364 | 1410 | 1429 |
| | 5 | 1360 | 1396 | 1425 |
| | 8 | 1355 | 1385 | 1400 |
| Potassium | 2 | 1363 | 1417 | 1444 |
| sulfate | 3 | 1359 | 1416 | 1440 |
| | 5 | 1338 | 1407 | 1435 |
| | 8 | 1331 | 1388 | 1414 |
| Sodium | 2 | 1324 | 1401 | 1434 |
| sulfate | 3 | 1269 | 1394 | 1415 |
| | 5 | 1252 | 1345 | 1399 |
| | 8 | 1239 | 1323 | 1335 |

TABLE 12
Influence of cosolvents boric anhydride, potassium sulfate,
and sodium sulfate on yellow phosphorus yield.

| | | Yellow phosphorus yield/% | | |
|---|---|---|---|---|
| | | Reaction | Reaction | Reaction |
| Cosolvent | | temperature | temperature | temperature |
| type | Addition/% | at 1,350° C. | at 1,400° C. | at 1,450° C. |
| No | 0 | 79.46 | 89.47 | 96.93 |
| cosolvent | | | | |
| Potassium | 2 | 72.76 | 88.58 | 92.21 |
| sulfate | 3 | 76.78 | 82.13 | 88.37 |
| Boric | 2 | 82.60 | 92.24 | 96.33 |
| anhydride | 3 | 88.15 | 91.50 | 97.43 |
| Sodium | 2 | 82.31 | 91.55 | 93.49 |
| sulfate | 3 | 77.90 | 83.15 | 90.74 |

As shown in Table 11 and FIGS. 4A-D, as the amount of cosolvent added increased, the deformation temperature DT, softening temperature ST, and fusion temperature FT of the material gradually decreased. When the addition was 8%, the cosolvents boric anhydride, potassium sulfate, and sodium sulfate reduced the fusion temperature of the material by 55° C., 41° C., and 120° C., respectively.

Moreover, as shown in FIGS. 4A-D, different cosolvents had different effects on the deformation temperature DT, softening temperature ST, and fusion temperature FT of the material. When the cosolvent was the sodium sulfate added at 8%, the fusion temperature decreased to a maximum extent.

As shown in Table 12, when the cosolvent was boric anhydride added at 3%, and the reaction temperature was 1,450° C., the yellow phosphorus yield was as high as 97.43%.

### Experimental Example 2

A rice test field in Zhengzhou, Henan was divided into 4 pieces on average, each of which was 1 mu, and the 4 test fields (with no significant difference in soil composition) were planted with rice and applied with different fertilizers:
CK: no fertilization;
T-1: a compound fertilizer produced by an enterprise in Shandong (19-10-17);
T-2: a compound fertilizer produced by an enterprise in Hubei (22-10-20);
T-3: 10 groups for the example: the compound fertilizer (16-8-11) prepared in Example 10 of the present disclosure; and

Each group was planted with rice and fertilized according to the method in Table 13, and other conditions were the same. After harvesting, the rice yield of each group was counted.

TABLE 13
Fertilizer application method and yield of each group.

| | | | Nutrient input | | | |
|---|---|---|---|---|---|---|
| | | | (kg/mu) | | | |
| | Fertilization | Fertilizer dosage | Pure | | | Yield |
| Group | method | (kg/mu) | N | P₂O₅ | K₂O | (kg/mu) |
| CK | — | — | — | — | — | 433.8 |
| T-1 | One base | Base fertilizer: | 7.75 | 4.08 | 6.94 | 636.3 |
| | fertilizer with | 28.6 | | | | |
| | one top | Top dressing: | | | | |
| | dressing | 12.2 | | | | |
| T-2 | One base | Base fertilizer: | 7.94 | 3.61 | 7.22 | 622.3 |
| | fertilizer with | 25.3 | | | | |
| | one top | Top dressing: | | | | |
| | dressing | 10.8 | | | | |
| T-3 | One-time base | 40 | 6.4 | 3.2 | 4.4 | 640.1 |
| | fertilizer | | | | | |
| | application | | | | | |

As shown in Table 13, compared with the control group CK and T-1 and T-2 groups, the fertilizer prepared by the present disclosure could still increase the yield of rice at a low nutrient input.

The above descriptions are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

What is claimed is:

1. A method for:
producing a by-product yellow phosphorus slag from said yellow phosphorus by an unconventional electric furnace process, comprising the following steps: mixing mid-low-grade phosphate rock, silica, coke, and a cosolvent to obtain a mixed material, and subjecting said mixed material to a high-temperature reduction in a yellow phosphorus electric furnace to obtain yellow phosphorus and a water-quenched slag; and drying said water-quenched slag with a yellow phosphorus tail gas to obtain said yellow phosphorus slag; wherein
said cosolvent is one selected from a group consisting of boromagnesite, boric anhydride, borax, potassium sulfate, and sodium sulfate;
said cosolvent is added at 0.1% to 10% of a weight of said mixed material based on a main oxide in said cosolvent;
SiO₂ and CaO in said mixed material are at a mass ratio of (0.7-0.9):1; and
said high-temperature reduction is conducted at 1,450° C.

2. The method according to claim 1, wherein said mid-low-grade phosphate rock comprises P₂O₅ with a content of greater than or equal to 23%.

3. A fertilizer containing said yellow phosphorus slag prepared by the method according to claim 1, wherein said fertilizer comprises urea, monoammonium phosphate, potassium chloride, yellow phosphorus slag, a calcium magnesium phosphate fertilizer, zinc sulfate, ammonium chloride, and attapulgite that are at a mass ratio of (15-30):(10-15):(20-25):(15-25):(3-7):(0.1-2):(10-30):(1-5).

4. The fertilizer according to claim 3, wherein a preparation method of the fertilizer comprises: mixing said urea, said monoammonium phosphate, said potassium chloride, said yellow phosphorus slag, said calcium magnesium phosphate fertilizer, said zinc sulfate, said ammonium chloride, and said attapulgite to allow granulation, drying, cooling, sieving, and packaging to obtain said fertilizer.

5. The fertilizer according to claim 4, wherein said granulation refers to one selected from said group consisting of extrusion granulation, powder granulation, and coated fertilizer granulation with said urea as a core.

6. The fertilizer according to claim 5, wherein said fertilizer is used as a base fertilizer applied at 35 kg/mu to 50 kg/mu.
